(19) United States
(12) Patent Application Publication
(10) Pub. No.: US 2005/0152582 A1
(43) Pub. Date: Jul. 14, 2005

(54) Multiple person detection apparatus and method

(75) Inventors: Sengmin Yoon, Yongin-si (KR); Seokcheol Kee, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/998,150

(22) Filed: Nov. 29, 2004

(30) Foreign Application Priority Data
Nov. 28, 2003 (KR) 10-2003-0085828

(51) Int. Cl. G06K 9/00; G06K 9/46

(52) U.S. Cl. 382/115; 382/190

(57) ABSTRACT

A multiple person detection apparatus and method. The multiple person detection apparatus includes a skin color detection unit, which detects at least one skin color region from a picked-up frame image by using skin color information, a candidate region determination unit, which determines whether or not each of the skin color regions belongs to a person candidate region, and a person determination unit, which determines whether or not the skin color region belonging to the person candidate region corresponds to a person by using person shape information.

### CROSS-REFERENCE TO RELATED APPLICATION

This application claims the priority of Korean Patent Application No. 2003-85828, filed on Nov. 28, 2003, in the Korean Intellectual Property Office, the disclosure of which is incorporated herein in its entirety by reference.

### BACKGROUND OF THE INVENTION

1. Field of the Invention

The present relates to object detection, and, more particularly, to a multiple person detection apparatus and a method of accurately and speedily detecting the presence of a person from an input image.

2. Description of the Related Art

As modern society becomes more complex and crime becomes more sophisticated, society's interest in protection is increasing and more and more public facilities are being equipped with a large number of security cameras. Since manually controlling a large number of security cameras is difficult, an automatic control system has been developed. In addition, recently, robots are being used for work in dangerous places or in the home instead of people. While at present, the operation of most robots is to repeat simple operations, in order to work intelligently, there must be good communication between robots and people. In order to enable such communication, robots must be able to accurately detect a person and operate in accordance with the person's commands.

Several face detection apparatuses to detect a person have been developed. In most of the face detection apparatuses, the motion of an object is detected by using a difference image that is between a background image stored in advance and an input image. Alternatively, a person is detected by using only shape information about the person, indoors or outdoors. The method using the difference image that is between the input image and the background image is effective when the camera is fixed. However, if the camera is attached to a moving robot, the background image continuously changes. Therefore, the method using the difference image is not effective. On the other hand, in the method using the shape information, a large number of model images must be prepared, and an input image must be compared with all the model images in order to detect the person. Thus, the method using the shape information is overly time-consuming.

### SUMMARY OF THE INVENTION

The present invention provides a multiple person detection apparatus and method of accurately and speedily detecting the presence of a person by using skin color information and shape information from an input image.

According to an aspect of the present invention, a multiple person detection apparatus comprises a skin color detection unit, which detects at least one skin color region from a picked-up frame image by using skin color information; a candidate region determination unit, which determines whether or not the skin color region belongs to a person candidate region; and a person determination unit, which determines whether or not the skin color region belonging to the person candidate region corresponds to a person by using person shape information.

According to another aspect of the present invention, a multiple person detection method comprises detecting at least one skin color region from a picked-up frame image by using skin color information; determining whether or not the skin color region belongs to a person candidate region; and determining whether or not the skin color region belonging to the person candidate region corresponds to a person by using person shape information.

According to still another aspect of the present invention, a computer-readable recording medium stores a program to execute the multiple person detection method.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a multiple person detection apparatus according to an embodiment of the present invention;

FIG. 2 is a detailed block diagram of a skin color detection unit of FIG. 1;

FIGS. 3A-3C show examples of images input to each component of FIG. 2;

FIG. 4 is a view to explain operation of a size normalization unit of FIG. 1;

FIG. 5 is a detailed block diagram of a candidate region determination unit of FIG. 1;

FIG. 6 is a view to explain operation of a distance map generation unit of FIG. 5;

FIG. 7 is a detailed block diagram of a person determination unit of FIG. 1;

FIGS. 8A to 8C show images input to each component of the person determination unit shown in FIG. 7; and

FIG. 9 is a flowchart of a multiple person detection method according an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

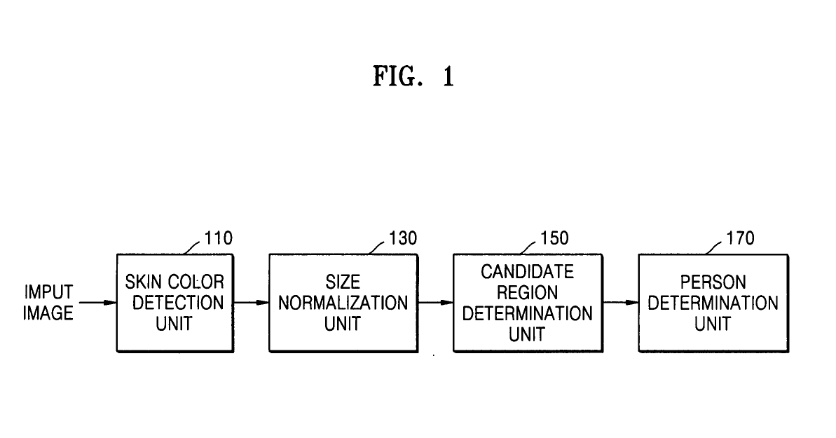

FIG. 1 is a block diagram showing a multiple person detection apparatus according to an embodiment of the present invention. The multiple person detection apparatus comprises a skin color detection unit 110, a size normalization unit 130, a candidate region determination unit 150, and a person determination unit 170.

The skin color detection unit 110 detects a skin color region from an input image that is transmitted from a moving or fixed camera. A color range is set in advance to cover human skin colors. In the skin color detection unit 110, skin color regions including colors that are similar to human skin color, that is, colors belonging to the color range are detected from the input image. The skin color detection unit 110 labels the skin color regions and calculates a size and a weight center of each of the labeled skin color regions.

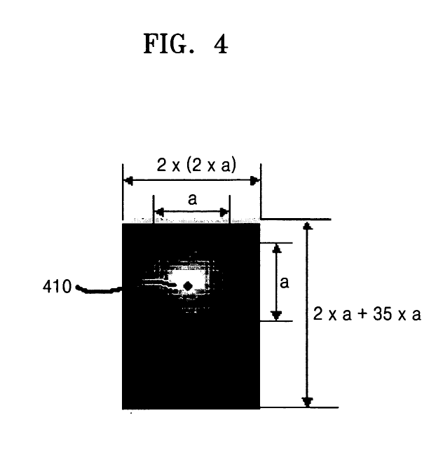

In response to the calculation of the sizes and weight centers of the skin color regions, the size normalization unit 130 normalizes the skin color regions with a predetermined size. This normalization will be described later with reference to FIG. 4.

The candidate region determination unit 150 then determines whether each of the skin color regions that are provided from the size normalization unit 130 corresponds to a person candidate region. A skin color region that does not correspond to the person candidate region is detected as background. A skin color region that corresponds to the person candidate region is provided to the person determination unit 170.

The person determination unit 170 determines whether or not each of the person candidate regions that are provided from the candidate region determination unit 150 corresponds to a person. A person candidate region corresponding to a person is detected as a person. A person candidate region not corresponding to a person is detected as background.

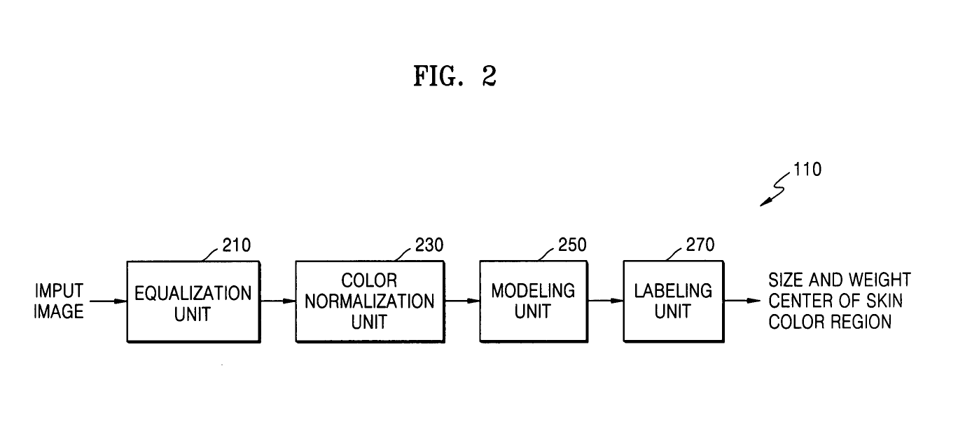

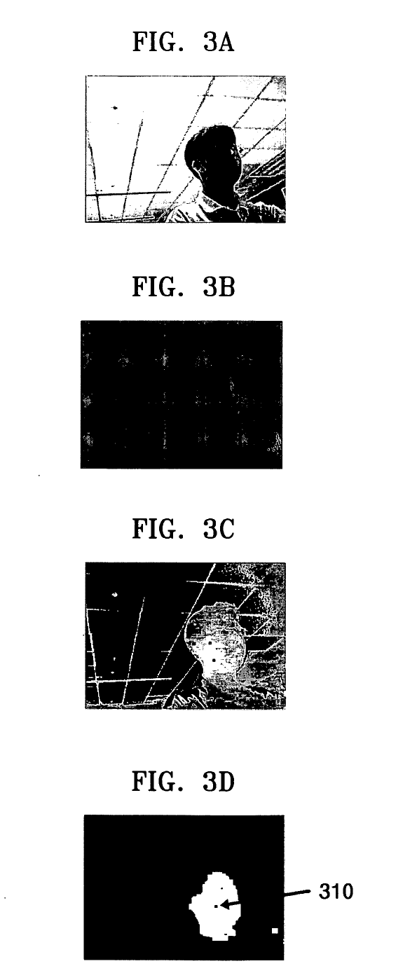

FIG. 2 is a block diagram of the skin color detection unit 110 of FIG. 1. The skin color detection unit 110 comprises an equalization unit 210, a color normalization unit 230, a modeling unit 250, and a labeling unit 270. The component units shown in FIG. 2 will be described with reference to FIGS. 3A through 3D, which show the input image, a color-normalized image, a modeling-processed image, and an extracted skin color region, respectively.

Referring to FIG. 2, the equalization unit 210 equalizes the input image shown in FIG. 3A in units of a frame to smooth an RGB histogram of the input image so as to reduce the influence of illumination on the entire input image.

The color normalization unit 230 color-normalizes the equalized image in units of a pixel to reduce the influence of illumination on pixels of the equalized image. Color normalization is performed as follows. Firstly, an RGB color space of pixels of the equalized image are transformed to an rgb color space using Equation 1 so as to generate the color-normalized image shown in FIG. 3B. The human skin color subjected to the color transform process has a Gaussian distribution.

$$r = \frac{R}{R + G + B} , g = \frac{G}{R + G + B} , b = \frac{B}{R + G + B} \\ r + g + b = 1 \qquad [ Equation 1 ]$$

The influence of illumination on the input image is removed by the equalization and color normalization processes. Therefore, the obtained image has colors unique to the object.

The modeling unit 250 produces the modeling-processed image shown in FIG. 3C by performing a 2-dimensional Gaussian modeling process on the color-normalized image provided from the color normalization unit 230, by using Equation 2, wherein mr and mg are color averages and σr and σg are standard deviations of colors r and g of multiple skin color models indoors and outdoors.

$$Z ( x , y ) = G ( r ( x , y ) , g ( x , y ) ) = \frac{1}{2 {πσ}_{r} {σ}_{g}} exp [ - \frac{1}{2} \{ {( \frac{r ( x , y ) - {m}_{r}}{{σ}_{r}} )}^{2} + {( \frac{g ( x , y ) - {m}_{g}}{{σ}_{g}} )}^{2} \} ] . \qquad [ Equation 2 ]$$

As a result of the Gaussian modeling process, the skin color region of the modeling-processed image is highlighted, and the other regions are blackened.

In the labeling unit 270, a pixel value of each pixel of the modeling-processed image is compared with a predetermined threshold value, for example, 240. Then, the color “black” is allocated to pixels having pixel values that are below the predetermined threshold value, and the color “white” is allocated to pixels having pixel values that are above the predetermined threshold value. Thus, a kind of binarization is performed. Consequently, at least one skin color region is extracted. Next, a labeling process is performed to allocate labels to the extracted skin color regions. In an embodiment of the invention, the labeling process is performed in accordance with sizes of the skin color regions. Next, the size and the coordinates of the weight center 310 of each of the labeled skin color regions are output. Each of the sizes of the labeled skin color region is represented by start and end points along x and y axes. The coordinates of the weight center 310 are calculated from the sum of pixel values of pixels of the labeled skin color region and the sum of coordinates pixels of the labeled skin color region.

FIG. 4 is a view to explain an operation of a size normalization unit 130 of FIG. 1. Firstly, a square region having an area a×a is set at the weight center 410 of each of the skin color regions detected by the skin color detection unit 110. Next, each skin color region is subjected to a first normalization process to elongate the horizontal and vertical sides of the square, such that the vertical side is longer than the horizontal side. For example, the horizontal side extends symmetrically in both directions from the center of weight 410 by 2×2a, that is, by left and right lengths 2a and 2a. The vertical side extends from the weight center 410 by 2a+3.5a, that is, by upward length 2a and downward length 3.5a. Here, in an embodiment of the invention, “a” is a positive square root of the size, that is, the area of the skin color region a=√(size). Next, a second normalization process is preformed on the first normalized skin color regions. Consequently, each of the second normalized skin color region has, as an example, 30×40 pixels. An image comprising the second normalized color regions having 30×40 pixels is called a “30×40-pixel normalized image.”

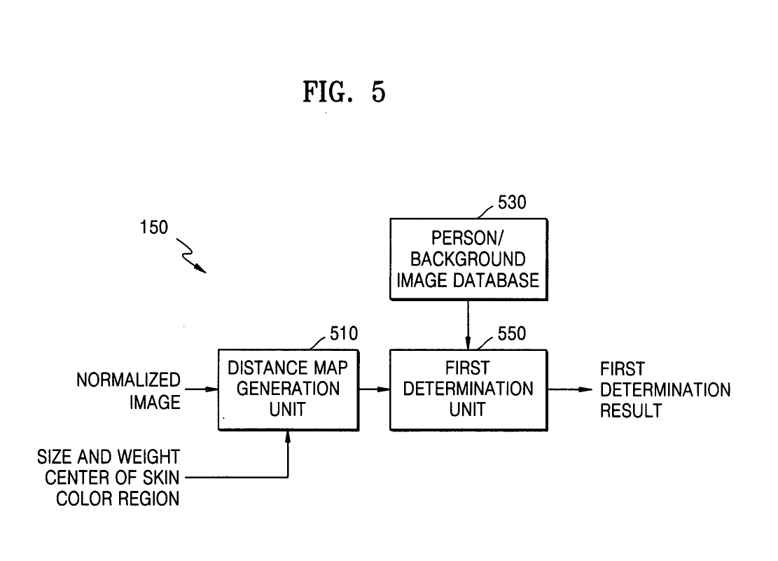

FIG. 5 is a block diagram of the candidate region determination unit 150 of FIG. 1. The candidate region determination unit 150 comprises a distance map generation unit 510, a person/background image database 530, and a first determination unit 550.

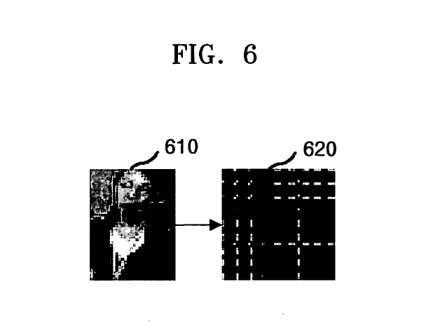

In response to the 30×40-pixel normalized image for the skin color regions provided from the size normalization unit 130 and the sizes and weight centers of the skin color regions, the distance map generation unit 510 generates a Mahalanobis distance map D to determine whether the skin color regions belong to person candidate regions. The Mahalanobis distance map D is described with reference to FIG. 6. Firstly, the 30×40-pixel normalized image 610 is partitioned into blocks. For example, the image 610 may be partitioned into 6 (horizontal) by 8 (vertical) blocks, that is, into 48 blocks. Each of the blocks has 5×5 pixels. The average of pixel values of each of the blocks is represented by Equation 3.

$${\overline{x}}_{l} = \frac{1}{pq} {\sum }_{( x , t ) ∈ {X}_{l}}^{} {x}_{s , t} \qquad [ Equation 3 ]$$

Here, p and q denote pixel numbers in the horizontal and vertical directions of a block, respectively. X denotes total blocks, and x denotes a pixel value in a block.

The variance of pixel values of the blocks is represented by Equation 4.

$${{\sum }_{l} =}^{} \frac{1}{pq} {\sum }_{x ∈ {X}_{l}}^{} ( x - {\overline{x}}_{l} ) {( x - {\overline{x}}_{l} )}^{T} \qquad [ Equation 4 ]$$

A Mahalanobis distance d(i, j) of each of the blocks is calculated by using the average and variance of pixel values of the blocks, as shown in Equation 5. The Mahalanobis distance map D is calculated by using the Mahalanobis distances d(i, j), as shown in Equation 6. Referring to FIG. 6, the image 610 may be converted into an image 620 using the Mahalanobis distance map D.

$$\begin{matrix}{d}_{( i , j )} = ( {\overline{x}}_{i} - {\overline{x}}_{j} ) {( {\sum }_{i} + {\sum }_{j} )}^{- 1} ( {\overline{x}}_{i} - {\overline{x}}_{j} ) & [ Equation 5 ] \\ D = [ \begin{matrix}0 & {d}_{( 1 , 2 )} & ⋯ & {d}_{( 1 , MN )} \\ {d}_{( 2 , 1 )} & 0 & ⋯ & {d}_{( 2 , MN )} \\ ⋮ & ⋮ & ⋮ & ⋮ \\ {d}_{( MN , 1 )} & {d}_{( MN , 2 )} & ⋯ & 0\end{matrix} ] & [ Equation 6 ]\end{matrix}$$

Here, M and N denote partition numbers of the image 610 in the horizontal and vertical directions, respectively. When the image 610 is partitioned into 6 (horizontal) by 8 (vertical) blocks, the Mahalanobis distance map D is represented by a MN×MN matrix, as an example, a 48×48 matrix.

The dimension of the Mahalanobis distance map (matrix) may be reduced by using a principal component analysis.

First, the first determination unit 550 compares the Mahalanobis distance map provided from the distance map generation unit 510 with a Mahalanobis distance map stored in the person/background image database 530. As described above, the Mahalanobis distance map provided from the distance map generation unit 510 is obtained from normalized skin color regions. On the other hand, the Mahalanobis distance map stored in the person/background image database 530 is obtained by a preparatory training method. The first determination unit 550 determines whether each of the normalized skin color regions belongs to a person candidate region based on the result of the Mahalanobis distance map comparison. If each of the normalized skin color regions does not belong to the person candidate region, a normalized skin color region is detected as background region. The person/background image database 530 and the first determination unit 550 are implemented by using a support vector machine (SVM) that is trained in advance to recognize thousands of person and background image models. The skin color regions determined to be person candidate regions by the first determination unit 550 are provided to the person determination unit 170.

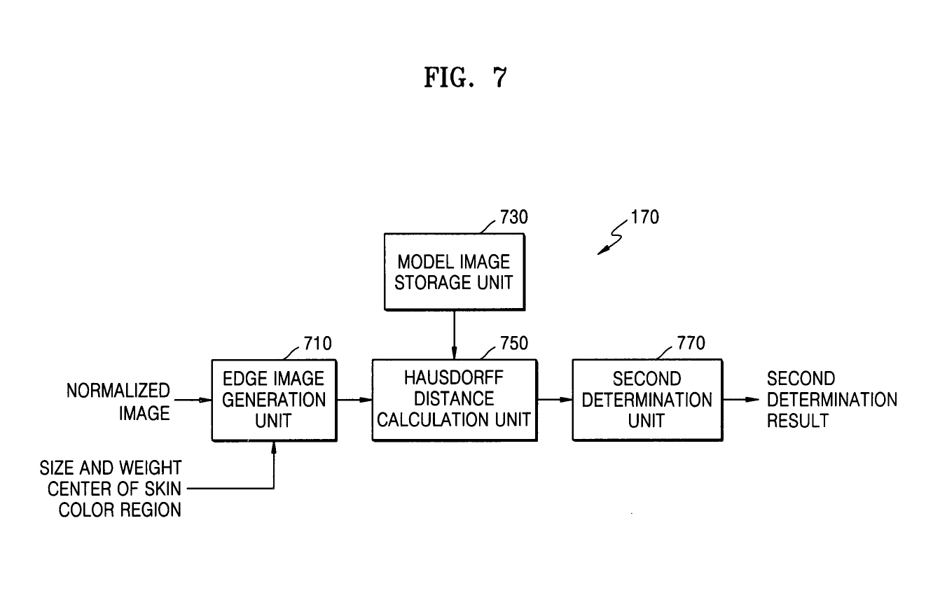

FIG. 7 is a block diagram of the person determination unit 170 of FIG. 1. The person determination unit 170 comprises an edge image generation unit 710, a model image storage unit 730, a Hausdorff distance calculation unit 750, and a second determination unit 770.

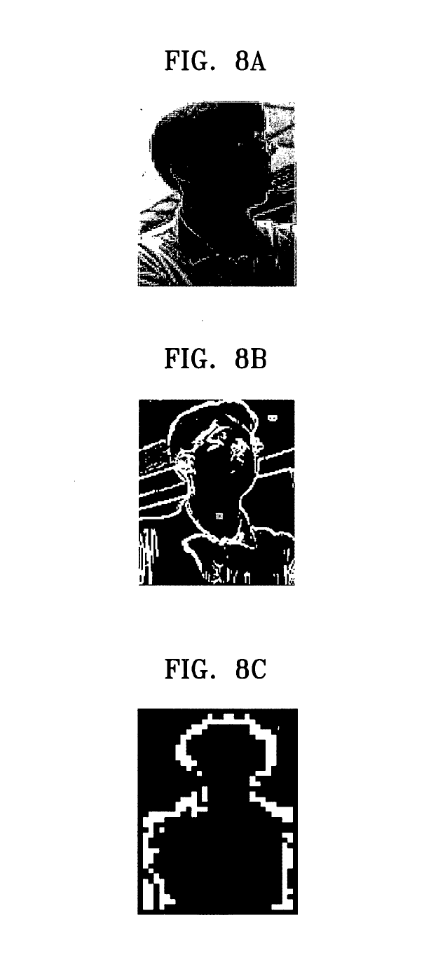

The edge image generation unit 710 detects edges from the person candidate regions out of the normalized skin color regions shown in FIG. 8A to generate an edge image shown in FIG. 8B. The edge image may be speedily and efficiently generated by using a Sobel edge method utilizing horizontal and vertical distributions of gradients in each pixel of an image.

The model image storage unit 730 stores at least one edge image of a model image. In an embodiment of the invention, the edge images of the model image include a front edge image showing the front of a person, a left edge image showing the same person facing a predetermined angle to the left, and a right edge image showing the same person facing a predetermined angle to the right. As an example, as shown in FIG. 8C, the front edge image of the model image is obtained by taking an average image of an upper-half of a person image in an entire image used for training and extracting edges of the average image. Consequently, by using a variety of rotated model images, person detection robust to pose changes may be achieved.

The Hausdorff distance calculation unit 750 calculates a Hausdorff distance between an edge image A generated by the edge image generation unit 710 and an edge image B of a model image stored in the model image storage unit 730 to evaluate similarity between both images. Here, the Hausdorff distance may be represented with Euclidian distances between one specific point, that is, one edge of the edge image A, and all the specific points, that is, all the edges, of the edge image B of the model image. In a case where an edge image A has m edges and an edge image B of the model image has n edges, the Hausdorff distance H(A, B) is represented by Equation 7.

$$\begin{matrix}H ( A , B ) = max ( h ( A , B ) , h ( B , A ) ) \\ Here , h ( A , B ) = {max}_{a ∈ A} {min}_{b ∈ B} ‖ a - b ‖ , \\ A = \{ a1 , … , am \} , and B = \{ b 1 , … , bn \} .\end{matrix} \\ \qquad [ Equation 7 ]$$

More specifically, the Hausdorff distance H(A, B) is obtained as follows. Firstly, h(A, B) is obtained by selecting minimum values of distances between each edge of the edge image A and all edges of the edge image B of the model images, and selecting a maximum value from among the minimum values for the m edges of the edge image A. Similarly, h(B, A) is obtained by selecting minimum values of distances between each edge of the edge image B of the model image and all edges of the edge image A, and selecting a maximum value from among the minimum values for the n edges of the edge image B of the model image. The Hausdorff distance H(A, B) is the larger of h(A, B) and h(B, A). By analyzing the Hausdorff distance H(A, B), evaluating a mismatch between the two images A and B is possible. With respect to the input edge image A, the Hausdorff distances for the entire model images stored in the model image storage unit 730 are calculated, and the largest of the Hausdorff distances is output as a final Hausdorff distance.

The second determination unit 770 compares the Hausdorff distance H(A, B) between the input edge image and the edge image of model images calculated by the Hausdorff distance calculation unit 750 with a predetermined threshold value. If the Hausdorff distance H(A, B) is equal to or greater than the threshold value, the person candidate region (skin color region) is detected as a background region. Otherwise, the person candidate region (skin color region) is detected as a person region.

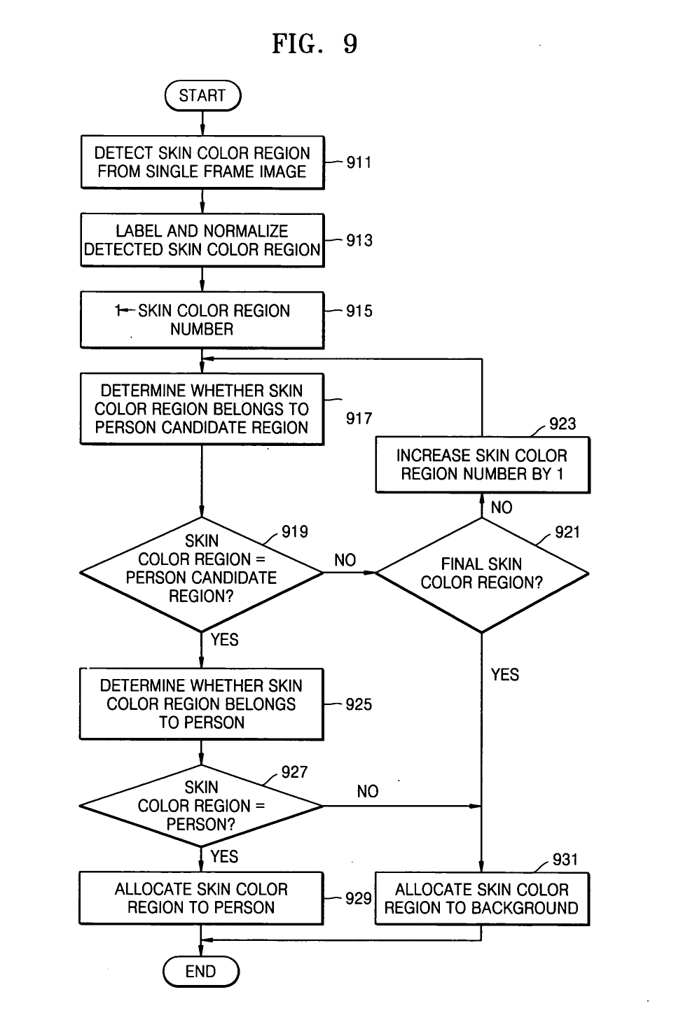

FIG. 9 is a flowchart of a multiple person detection method according an embodiment of the present invention.

In operation 911, at least one skin color region is detected from a single frame image picked-up by a camera by using predetermined skin color information. In advance of detecting the skin color regions, a color normalization process is performed on the entire frame image and the pixels of the frame image in order to reduce the effects of illumination on the frame image. On the other hand, a Gaussian modeling process is performed on the frame image to highlight pixels having colors similar to skin color, and then, skin color regions including pixels having pixel values above a predetermined threshold value are detected.

In operation 913, the skin color regions detected in operation 911 are labeled and sizes and centers of weight of the labeled skin color regions are generated. The skin color regions are normalized with a predetermined size by using the sizes and centers of weight of the skin color regions.

In operation 915, a first skin color region is selected from at least one detected skin color region.

In operations 917 and 919, whether the selected skin color region belongs to a person candidate region is determined using the Mahalanobis distance map D and the SVM that are shown in FIG. 6. If the skin color region does not belong to the person candidate region, in operation 921, whether the current skin color region is the final skin color region out of the detected skin color regions is determined. If the current skin color region is the final skin color region, the current skin color region is detected as background in operation 931. If the current skin color region is not the final skin color region, the skin color region number increases by 1 in operation 923, and operation 917 is repeated for the next skin color region.

In operations 925 and 927, if the current skin color region belongs to the person candidate region, whether the current skin color region corresponds to a person is determined. If the current skin color region corresponds to a person, the current skin color region is detected as a person in operation 929. If the current skin color region does not correspond to a person, the current skin color region is detected as background in operation 931,

As is described above, a multiple person detection method and apparatus according to the present invention may be adapted to be used in security surveillance systems, broadcast and image communications, speech recognition robots, and as an intelligent interface with household electronic appliances. As an example, a robot may be controlled to turn toward a detected person, or the direction and/or strength of an air-conditioner may be controlled so that air is blown toward a detected person.

The invention may also be embodied as computer-readable codes stored on a computer-readable recording medium. The computer-readable recording medium is any data storage device that can store data that may thereafter be read by a computer. Examples of the computer-readable recording medium include read-only memory (ROM), random-access memory (RAM), CD-ROMs, magnetic tapes, floppy disks, optical data storage devices, and carrier waves (such as data transmission over the Internet). The computer-readable recording medium may also be distributed over network of coupled computer systems so that the computer-readable code is stored and executed in a distributed fashion. Computer programmers having ordinary skill in the art, may relatively easily write operational programs, codes, and code segments to accomplish the present invention.

As is described above, according to the present invention, a plurality of person candidate regions are detected from an image picked up by a camera indoors or outdoors by using skin color information. Next, by determining whether or not the person candidate region corresponds to a person based on person shape information, it is possible to speedily and accurately detect a plurality of persons in one frame image. In addition, in a multiple person detection method and apparatus according to the present invention, it is possible to accurately detect a person even if the person's pose and/or illumination conditions change.

Although a few embodiments of the present invention have been shown and described, it would be appreciated by those skilled in the art that changes may be made in these embodiments without departing from the principles and spirit of the invention, the scope of which is defined in the claims and their equivalents.

1. A multiple person detection apparatus comprising:
a skin color detection unit, which detects at least one skin color region from a picked-up frame image by using skin color information;
a candidate region determination unit, which determines whether each of the skin color regions belongs to a person candidate region; and
a person determination unit, which determines whether the skin color region belonging to the person candidate region corresponds to a person by using person shape information.

2. The multiple person detection apparatus according to claim 1, wherein the skin color detection unit comprises:
a color normalization unit, which normalizes colors of pixels of the frame image;
a modeling unit, which performs a Gaussian modeling process on the normalized frame image to highlight pixels having colors similar to skin color; and
a labeling unit, which performs a labeling process on pixels having pixel values above a predetermined threshold value among the pixels having colors similar to the highlighted skin color to detect at least one skin color region, and generates sizes and weight centers of the skin color regions.

3. The multiple person detection apparatus according to claim 1, wherein the candidate determination unit normalizes the skin color regions detected by the skin color detection unit with a predetermined size, and determines whether each of the normalized skin color regions belongs to the person candidate region by using a Mahalanobis distance map.

4. The multiple person detection apparatus according to claim 1, wherein the person determination unit comprises:
an edge image generation unit, which generates an edge image for the person candidate region;
a model image storage unit, which stores an edge image of a model image;
a similarity evaluation unit, which evaluates similarity between the edge image of the model image and the edge image generated by the edge image generation unit; and
a determination unit, which determines whether the person candidate region corresponds to a person based on the evaluated similarity.

5. The multiple person detection apparatus according to claim 4, wherein the model image is constructed with at least one of a front model image, a left model image, and a right model image.

6. A multiple person detection method comprising:
detecting at least one skin color region from a picked-up frame image by using skin color information;
determining whether each of the skin color regions belongs to a person candidate region; and
determining whether the skin color region belonging to the person candidate region corresponds to a person by using person shape information.

7. The multiple person detection method according to claim 6, wherein the detecting at least one skin color region comprises:
normalizing colors of pixels of the frame image;
performing a Gaussian modeling process on the normalized frame image to highlight pixels having colors similar to skin color; and
performing a labeling process on pixels having pixel values above a predetermined threshold value among the pixels having colors similar to the highlighted skin color to detect at least one skin color region, and generating sizes and centers of weight of the skin color regions.

8. The multiple person detection method according to claim 7, wherein the detecting at least one skin color region further comprises, prior to detecting at least one skin color region, smoothing an RGB histogram of the frame image by equalizing the frame image.

9. The multiple person detection method according to claim 7, wherein, in normalizing colors of pixels of the frame image, the colors are normalized in accordance with the following equation:
$$r = \frac{R}{R + G + B} , g = \frac{G}{R + G + B} , b = \frac{B}{R + G + B}$$
$$r + g + b = 1 ,$$
wherein r, g, and b denote normalized color signals, and R, G, and B denote color signals of the input frame image.

10. The multiple person detection method according to claim 7, wherein, in performing a Gaussian modeling process, the Gaussian modeling process is performed in accordance with the following equation:
$$\begin{matrix}Z ( x , y ) = G ( r ( x , y ) , g ( x , y ) ) \\ = \frac{1}{2 {πσ}_{r} {σ}_{g}} exp [ - \frac{1}{2} ( {( \frac{r ( x , y ) - {m}_{r}}{{σ}_{r}} )}^{2} + {( \frac{g ( x , y ) - {m}_{g}}{{σ}_{g}} )}^{2} \} ] ,\end{matrix}$$
wherein mᵣ and mg denote averages of colors r and g of multiple skin color models and σᵣ and σ_{g} denote standard deviations of colors r and g of the multiple skin color models.

11. The multiple person detection method according to claim 6, wherein the determining whether or not each of the skin color regions belongs to a person candidate region comprises:
normalizing the detected skin color regions with a predetermined size; and
determining whether each of the normalized skin color regions belongs to the person candidate region.

12. The multiple person detection method according to claim 11, wherein the determining whether each of the normalized skin color regions belongs to the person candidate region is performed by using a Mahalanobis distance map.

13. The multiple person detection method according to claim 12, wherein, the Mahalanobis distance map is obtained by:
partitioning the normalized image into M (horizontal)×N (vertical) blocks;
obtaining an average of distances of blocks using the following equation:
$${\overline{x}}_{l} = \frac{1}{pq} {\sum }_{( x , t ) ∈ {X}_{1}}^{} {x}_{s , t}$$
wherein p and q denote pixel numbers in the horizontal and vertical directions of each block, respectively, X denotes total blocks, and x denotes a pixel value in each block;
obtaining the deviation of pixel values of each block using the following equation:
$${\sum }_{l} = \frac{1}{pq} {\sum }_{x ∈ {X}_{l}}^{} ( x - {\overline{x}}_{l} ) {( x - {\overline{x}}_{l} )}^{T}$$
obtaining the Mahalanobis distance d(i, j) of each of the blocks and the Mahalanobis distance map D having the form of a matrix (M×N)×(M×n) by using the following equations:
$${d}_{( i , j )} = {( {\overline{x}}_{i} , {\overline{x}}_{j} )}^{′} {( {\sum }_{i} + {\sum }_{j} )}^{- 1} ( {\overline{x}}_{i} - {\overline{x}}_{j} ) and$$
$$D = [ \begin{matrix}0 & {d}_{( 1 , 2 )} & … & {d}_{( 1 , MN )} \\ {d}_{( 2 , 1 )} & 0 & … & {d}_{( 2 , MN )} \\ ⋮ & ⋮ & ⋮ & ⋮ \\ {d}_{( MN , 1 )} & {d}_{( MN , 2 )} & … & 0\end{matrix} ]$$

14. The multiple person detection method according to claim 6, wherein the determining whether the skin color region belonging to the person candidate region corresponds to a person comprises:
generating an edge image for the person candidate region;
evaluating similarity between an edge image of a model image and the generated edge image;
determining based on the evaluated similarity whether the person candidate region corresponds to a person.

15. The multiple person detection method according to claim 14, wherein the similarity is evaluated based on a Hausdorff distance.

16. The multiple person detection method according to claim 15, wherein the input edge image A has m edges, and the model image B has n edges,
wherein the Hausdorff distance is obtained by using the following equations:
$$H ( A , B ) = max ( h ( A , B ) , h ( B , A ) ) and$$
$$h ( A , B ) = {max}_{a ∈ A} {min}_{b ∈ B} ‖ a - b ‖ , A = \{ a1 , … , am \} , and B = \{ b1 , … , bn \} .$$

17. The multiple person detection method according to claim 14, wherein the model image is constructed with at least one of a front model image, a left model image, and a right model image.

18. A computer-readable recording medium storing a program to execute a multiple person detection method comprising:
detecting at least one skin color region from a picked-up frame image by using skin color information;
determining whether each of the skin color regions belongs to a person candidate region; and
determining whether the skin color region belonging to the person candidate region corresponds to a person by using person shape information.
